(19) United States
(12) Patent Application Publication
(10) Pub. No.: US 2022/0161068 A1
(43) Pub. Date: May 26, 2022

(54) SYSTEMS, DEVICES, AND METHODS FOR PROTECTING AGAINST RESPIRATORY HAZARDS USING DIFFERENT MODES

(71) Applicant: HUMANSYSTEMS INCORPORATED, Guelph (CA)

(72) Inventors: Harold Alexander ANGEL, Guelph (CA); Jordan James Bray-Miners, Guelph (CA)

(21) Appl. No.: 17/555,041

(22) Filed: Dec. 17, 2021

Related U.S. Application Data
(63) Continuation-in-part of application No. 17/545,567, filed on Dec. 8, 2021.
Application No. 17/545,567 is a continuation of application No. PCT/CA2021/051104, filed on Aug. 10, 2021.
(60) Provisional application No. 63/063,616, filed on Aug. 10, 2020.

(51) Int. Cl. A62B 18/04; A62B 18/02; A62B 18/08; A62B 9/00; A62B 7/10

(52) U.S. Cl. CPC A62B 18/045; A62B 18/02; A62B 7/10; A62B 9/006; A62B 18/084

(57) ABSTRACT

A system for protecting against respiratory hazards, the system comprising a hood configured to cover a head of a user and interface with a mask, when the mask is positioned on a face of the user; an air blower connected with the hood in order to provide air to an interior of the hood; at least one pressure sensor coupled to a controller, the at least one sensor for measuring air pressure at a selected location; and the controller to receive data from the at least one pressure sensor and configured to control the air blower to dynamically adjust the air pressure in the interior of the hood to a set pressure, such that the controller configures operation of the air blower by an operational mode selected from a plurality of operational modes, such that each of the operational modes are represented by a different set of operational parameters including the set pressure.

### RELATED APPLICATIONS

The application is a continuation-in-part of U.S. patent application Ser. No. 17/545,567, filed Dec. 8, 2021, which is a continuation of PCT/CA2021/051104, filed Aug. 10, 2021, which claims priority to U.S. Provisional Patent Application No. 63/063,616, filed Aug. 10, 2020, the contents of which are hereby incorporated herein by reference.

### FIELD

The present disclosure relates to systems, devices and methods for protecting against respiratory hazards and, in particular to respiratory masks and hoods for protection against respiratory hazards.

### BACKGROUND

There are many situations where people need to be protected against respiratory hazards such as airborne contaminants, biological contaminants, dusts, mists, fumes, and gases, oxygen-deficient atmospheres, among others. In the military defense industry, it may be necessary to protect against and operate in a Chemical Biological Radiological and Nuclear (CBRN) environment.

The industrial and military industries have long acknowledged the challenges in maintaining respiratory mask seal for personnel having variations in head shape that are outside of a “standard” shape (due to gender or other differences) or those with glasses, longer hair, beards or stubble. In particular, the impact of facial hair on respiratory protective masks is well known. AS/NZ1 715 states that “ . . . individuals who have stubble (even a few days' growth will cause excessive leakage of contaminant), a moustache, sideburns, or a beard which passes between the skin and the sealing surface should not wear a respirator which requires a facial seal.” Further, some individuals may have smaller faces and may be disaccommodated with many mask designs. Respirator design is challenged by the morphological diversity of the population, fielding a system with more than three or four sizes can be challenging. As well masks developed for a North American population may also disaccommodate visible minorities and aboriginals. The need to provide respiratory protection to a varied population is important in a diverse society.

Another potential source of mask leakage is during movement of a subject's head or upper body. In the military context, it is known that rifle firing has been shown to cause leakage as the mask face piece can be contorted when soldiers align their eye to the sights.

With regard to vision correction, at least some conventional respirators utilize clip on vision inserts to provide vision correction for users who require prescription lenses. Generally, the use of traditional prescription glasses has not been possible due to mask seal leaks at the temple arm mask seal interface.

While powered full encapsulation, Positive Air Pressure respirators (PAPR) and Self-Contained Breathing Apparatus (SCBA) can provide respiratory protection in some cases, these type of devices can be cumbersome, heavy, and difficult to put on. SCBA and PAPR systems are also generally only used for relatively short durations due to their relatively large consumption of electrical power and/or their limited air supply. These systems can also require fill stations or replacement batteries as a power source. In extreme cases, SCBA system can experience failures that can result in injuries from the SCBA system itself.

It is recognised that in the state of the art, commonly used are pressurized gas masks such as those used by firefighters. However, it is recognised that issues with pressurized gas masks still include possible seal leaks, for example due to the presence of facial hair and/or due to changing activity levels of the user. A further issue with pressurized gas masks is that perspiration of the user can cause the position of the mask to be undesirably displaced from an optimum position on the face of the user. Further, it is recognised that in the field, the seals associated with the gas mask can tear and thus pose potential areas of catastrophic failure for the pressurized gas mask systems relying upon seal integrity to keep the user from breathing in noxious substances.

Further issues with state of the art pressurized systems can include limitations in system resources in the field, for example a limited supply of air in the case of pressurized tanks and/or limited battery life where power is required to maintain the desired operation of the pressurized system.

Further, it is recognised that hoods can be worn over the head of the user, in conjunction with a sealed/pressurized mask system, in order to areas of the user's head not covered by the mask. However, these state of the art ancillary hoods still do not account for the issues described above, such as seal failure and/or suboptimal position of the mask on the face of the user.

There is thus a need for improved systems, devices and methods for protection from respiratory hazards, including masks, hoods, and processes and methods for making and using the same to help reduce the risk of a poor mask seal.

### SUMMARY

This summary is provided to introduce a selection of concepts in a simplified form that are further described below in the Detailed Description. This summary is not intended to cover each and every feature of the claimed subject matter, nor is it intended to be used as an aid in determining the scope of the claimed subject matter.

It is an object of the present invention to provide systems, devices and methods for protection from respiratory hazards, including masks, hoods, and processes and methods for making and using the same to obviate or mitigate at least one of the above-presented disadvantages.

As described herein, there is provided a system including a respiratory overpressure hood, a respiratory mask system including an overpressure hood, and method of using the same to reduce the leakage of contaminants into the mask when the mask is in use.

A first aspect provided is a system for protecting against respiratory hazards, the system comprising a hood configured to cover a head of a user and interface with a mask, when the mask is positioned on a face of the user; an air blower connected with the hood in order to provide air to an interior of the hood; at least one pressure sensor coupled to a controller, the at least one sensor for measuring air pressure at a selected location; and the controller to receive data from the at least one pressure sensor and configured to control the air blower to dynamically adjust the air pressure in the interior of the hood to a set pressure, such that the controller configures operation of the air blower by an operational mode selected from a plurality of operational modes, such that each of the operational modes are represented by a different set of operational parameters including the set pressure.

A second aspect provided is a method for protecting against respiratory hazards using system having a hood coupled to a mask with an air blower connected with the hood in order to provide air to an interior of the hood, the method comprising: selecting a first operational mode of an air blower from a plurality of operational modes; operating the air blower based on a first parameter set associated with the first mode in conjunction with available pressure readings from an air pressure sensor; selecting a second operational mode of the air blower from the plurality of operational modes; and operating the air blower based on a second parameter set associated with the first mode in conjunction with available pressure readings from an air pressure sensor, such that the second parameter set is different from the first parameter set.

According to an aspect herein, a system, devices and method for protecting against respiratory hazards includes a mask, an overpressure hood configured to work with the mask, an air blower configured to provide air to the overpressure hood, at least one pressure sensor, and a controller to control the blower to maintain a predetermined pressure in the overpressure hood. In some cases, the hood includes a manifold system to manage and attempt to optimize air flow inside the hood.

According to an aspect herein, a system for protecting against respiratory hazards includes a mask for placement on a face of a user, a hood configured to cover the head of the user and interface with the mask, an air blower configured to provide air to the hood, at least one filter configured to filter air entering the hood via the air blower, at least one pressure sensor, provided to the hood, and a controller to receive data from the at least one pressure sensor and configured to control the blower to maintain a predetermined air pressure in the hood.

In some cases, the system further includes a manifold configured to distribute air flow received from the blower inside the hood. In some cases, the manifold system includes a branching tube to conduct air flow to predetermined areas of the hood. In some cases, the at least one pressure sensor includes a pressure sensor configured to sense a pressure inside the hood. In some cases, the at least one pressure sensor includes an inlet pressure sensor provided at a blower inlet and an outlet pressure sensor provided at a blower outlet. In some cases, the hood and mask are configured to connect and form a seal. In some cases, the hood includes a connector for connecting the hood around the mask to limit entry of air into the hood. In some cases, the controller controls the blower based on predetermined pressure levels.

According to an aspect herein, a method for protecting against respiratory hazards includes measuring at least one pressure reading related to the system, determining if the at least one pressure reading is less than a predetermined low pressure limit and, if so, increasing the blower power, determining if the at least one pressure reading is greater than a predetermined high pressure limit and, if so, decreasing the blower power, and return to measuring the at least one pressure reading.

In some cases, the method further includes determining if the at least one pressure reading is less than a predetermined critical limit and, if so, setting a blower power to a maximum. In some cases, the method further includes waiting a predetermined period before returning to measuring the at least one pressure reading. In some cases, the at least one pressure reading includes a blower inlet pressure reading and a blower outlet pressure reading and the blower outlet pressure reading is used in the determinations while the blower inlet pressure reading is used to determine if the blower or hose is blocked.

### BRIEF DESCRIPTION OF FIGURES

Further features and exemplary advantages will become apparent from the following detailed description, taken in conjunction with the appended drawings, in which:

FIG. 1 (PRIOR ART) shows a conventional respirator mask without a hood worn by a user and a process of donning the respirator mask;

FIG. 2A is a schematic diagram for a system of FIG. 3A for protecting against respiratory hazards according to an embodiment herein;

FIG. 2B is a schematic diagram for another embodiment of the system of FIG. 3A for protecting against respiratory hazards;

FIG. 3A is a side view of a system for protecting against respiratory hazards according to an embodiment herein;

FIG. 3B shows a more detailed view of a belt, blower and power for the system of FIG. 3A with a cut away of the blower;

FIG. 3C shows a front view of a manifold system for the system of FIG. 3A;

FIG. 3D shows a side view of the hood and mask for the system of FIG. 3A with the hood shown as transparent;

FIG. 4 shows an example circuit diagram for an embodiment of a controller for a system such as the system in FIG. 2A-B or FIG. 3A-C;

FIG. 5A shows an embodiment of a method for protecting against respiratory hazards for the system of FIG. 3A;

FIG. 5B shows another embodiment of a method for protecting against respiratory hazards for the system of FIG. 3A;

FIG. 6 shows a graph of hood pressure as a function of blower power in a first test for the system of FIG. 3A;

FIG. 7 shows a graph of hood pressure as a function of blower power in a second test for the system of FIG. 3A; and

FIG. 8 shows a flowchart of a further operation of the system of FIG. 3A.

### DETAILED DESCRIPTION

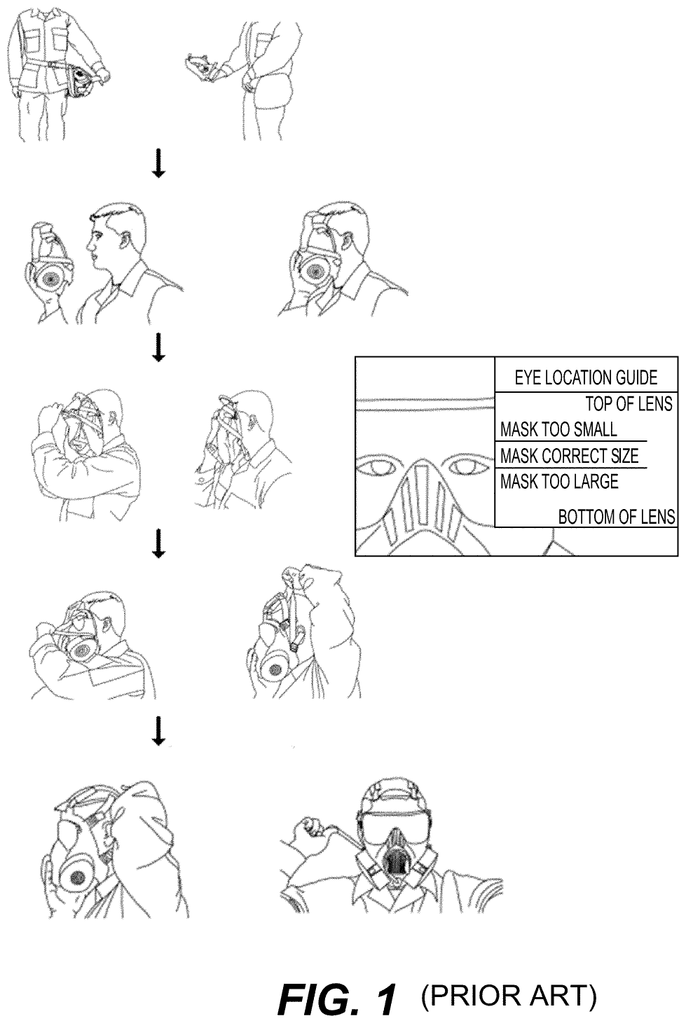

FIG. 1 shows a conventional respirator mask without a hood worn by a user and a process of donning the respirator mask. As shown in FIG. 1, there can be issues of potential leakage and risk if the mask is too large or too small and if the mask is not placed properly with straps tightened accordingly. There can also be issues for users that have different hairstyles or head coverings, facial hair, glasses, or the like.

Generally speaking, the embodiments of the system, device and methods described herein are intended to provide respiratory protection to individuals who do not achieve adequate protection with existing respirators, for example due to varied head/face shape, the presence of facial hair, loose scalp hair or head coverings, the presence of prescription eyewear temple arms, or the like. The embodiments of the system and method described herein combines the protection provided by an improved respirator mask with an over pressured hood system.

In particular, in some embodiments, the system includes an overpressure hood that works with the respirator mask to deal with any potential leaks of the respirator mask. The over pressure hood is configured to form a seal with both the respirator mask and lower neck of the user. In order to compensate for any imperfections in this hood seal, a compact blower system tethered to the hood uses filtered air to create a positive pressure gradient between the air inside the hood and in the surrounding environment. The positive pressure gradient has been shown by the inventors to reduce vapor and aerosol contamination into the mask relative to conventional masks lacking an overpressure hood.

In some cases, embodiments of the system herein may be configured to combine or work with existing CBRN protective respiratory protection systems.

In this disclosure, the term “about” is used to mean that the value or data associated with this term (such as a length) can vary within a certain range depending on the margin of error of the method or device used to evaluate or measure such value or data. A margin or variation of up to about 10% is typically accepted to be encompassed by the term “about”.

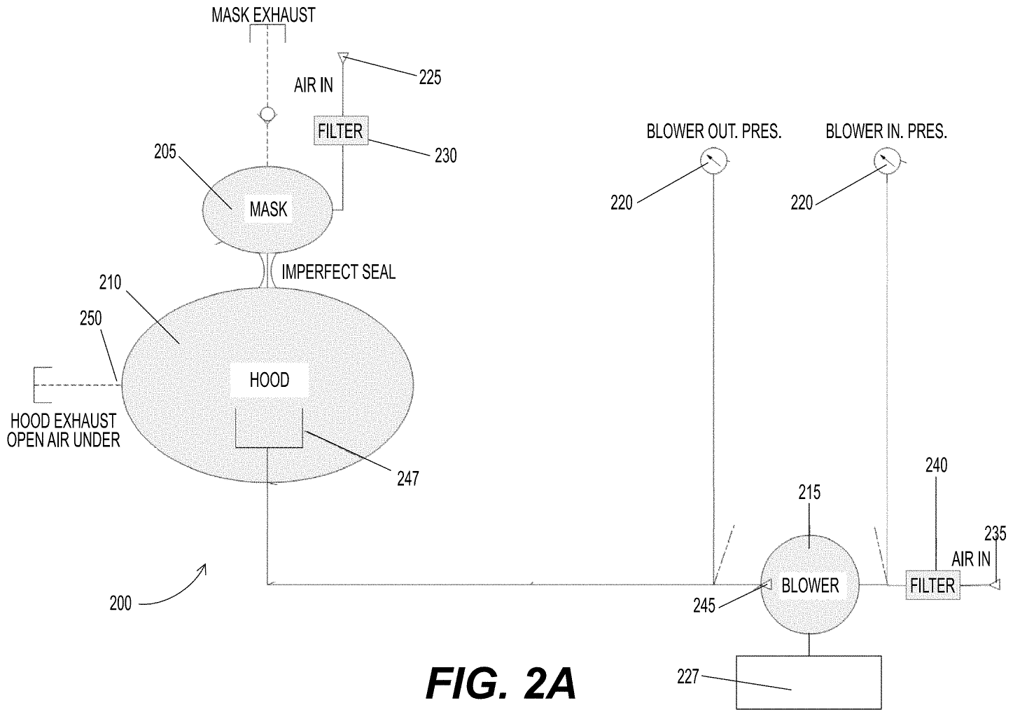

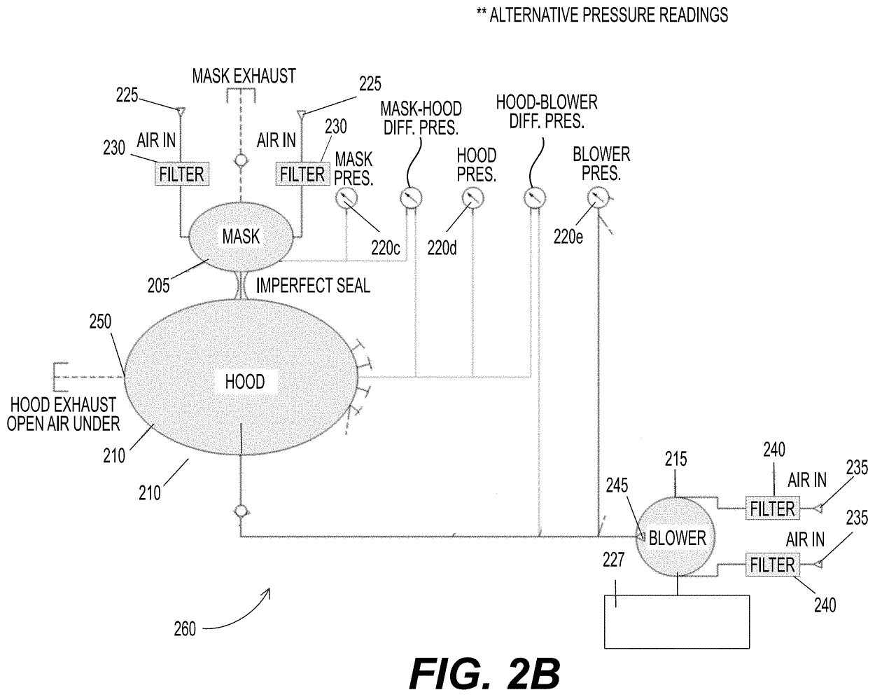

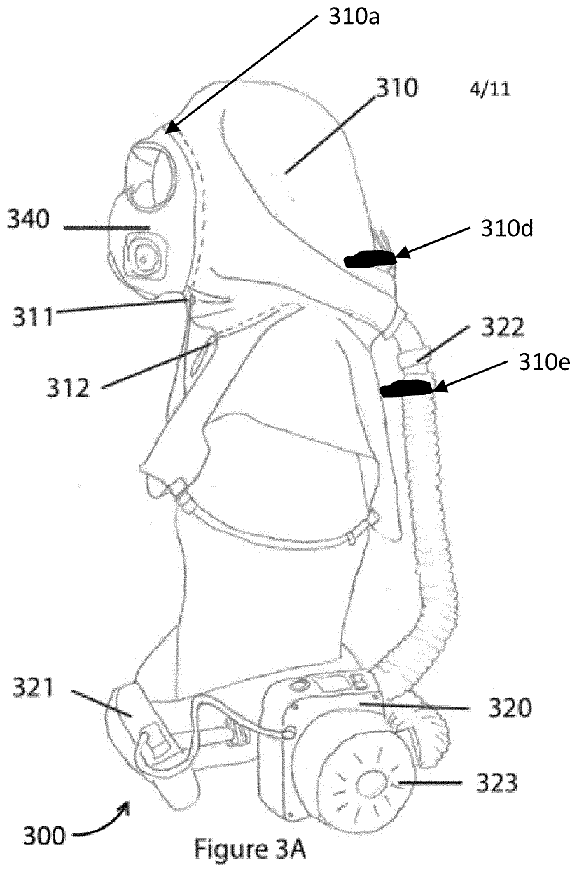

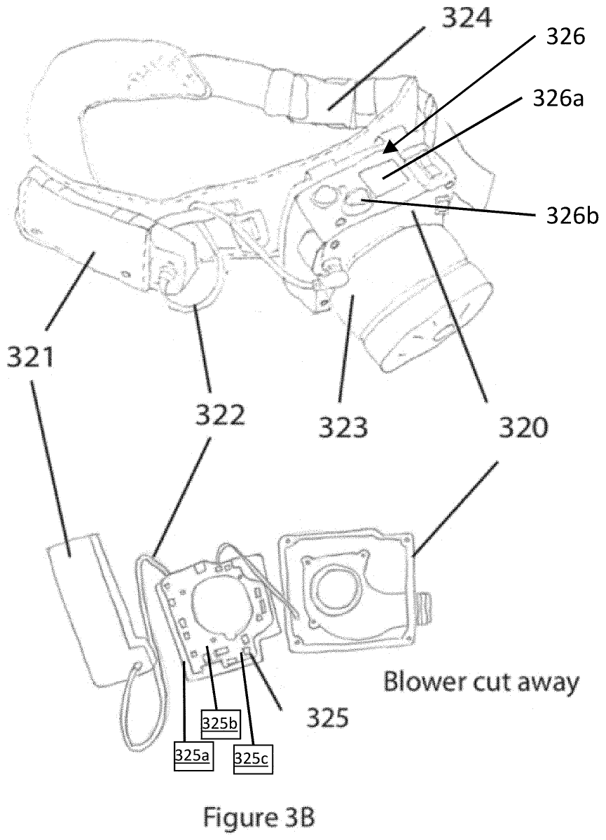

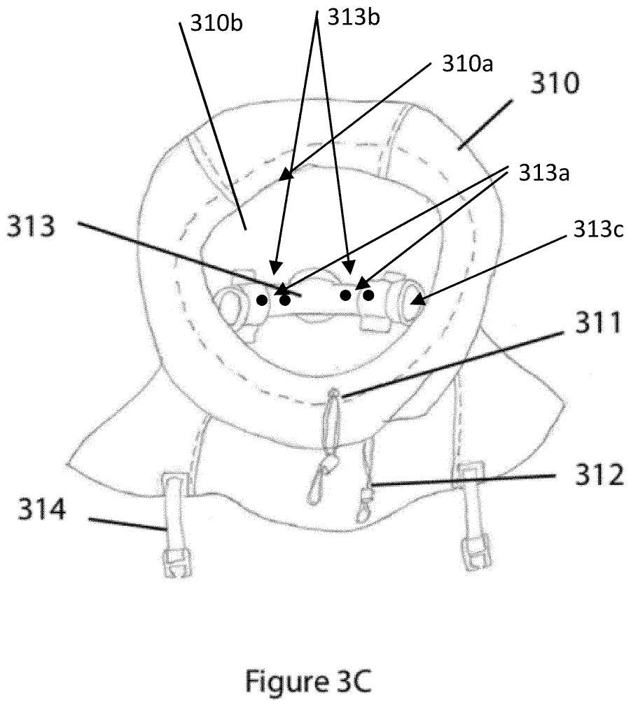

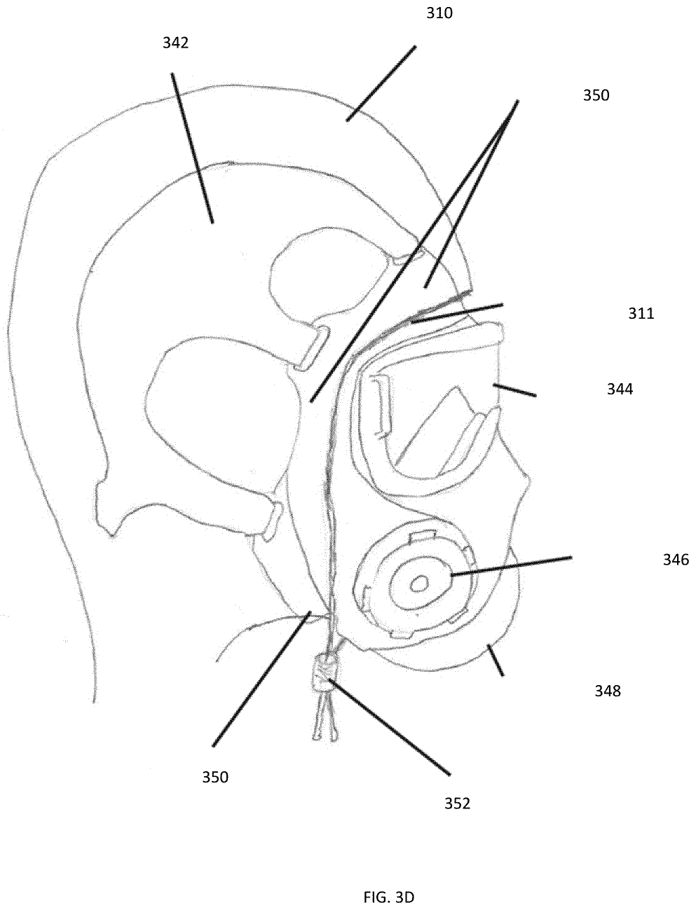

FIG. 2A is a schematic diagram of an embodiment of a system 200 for protecting against respiratory hazards. The system 200 includes a mask 205, an overpressure hood 210, a blower 215, one or more pressure sensors 220, and a controller 227 for receiving data from the one or more pressure sensors 220 and controlling the blower 215. The mask 205 includes a mask inlet 225, which includes a mask filter 230, as well as a mask exhaust. The blower 215 includes a blower inlet 235, which includes a blower filter 240, and a blower outlet 245 that connects with the overpressure hood 210. The blower outlet 245 may include an air diverter/manifold 247 that is positioned inside the overpressure hood 210. The overpressure hood 210 is in contact with (or is otherwise placed adjacent to) the mask 205 and has a hood exhaust 250, which may be the nature of the connection with the mask 205. The pressure sensor(s) 220 may be placed as appropriate. In this embodiment, there are two pressure sensors 220, one for sensing the blower in pressure 220a and one for sensing the blower out pressure 220b. It is also recognised that a pressure sensor 220 can be positioned in the interior of the hood 210, in order to measure the internal pressure of the hood 210 in real time. The readings of the pressure sensor(s) 220 can be used by the controller 227 to affect the operational parameter(s) (e.g. fan speed) of the blower 215 (also referred to as blower 320 with controller 325—see FIG. 3A).

FIG. 2B is a schematic diagram of another embodiment of a system 260 for protecting against respiratory hazards. The system 260 includes similar elements to those in the system 200 and similar reference numbers are used in FIG. 2A. The system 260 includes the respirator mask 205, the overpressure hood 210, the blower 215, the pressure sensor 220, and the controller 227. The system 260 also includes additional mask filters 230 and blower filters 240 as well as alternative sensors 220. In this embodiment, the sensors 220 can include mask pressure 220c, hood pressure 220d, and/or blower pressure 220e. The mask pressure sensor 220c and hood pressure 220d can be used to determine a mask/hood differential pressure. Similarly, the hood pressure 220d and the blower pressure 220e can be used to determine a hood/blower differential pressure. In this embodiment, the blower outlet 245 does not include an air diverter manifold 247.

In embodiments herein, it will be understood that various air flows may move through hoses or the like and that, where appropriate, there may be one-way valves or the like to prevent air flow in a direction which is not intended.

FIG. 3A shows a side view of a prototype of an embodiment of the system protecting against respiratory hazards 300. The system 300 includes a hood 310, a blower 320, a power supply 321, an air hose 322, a CBRN filter 323, a blower controller 325, and a mask 340. The mask 340 is worn on a face of a user and the head of the user is covered by the hood 310. The hood 310 is configured to interface with the mask 340. In some cases, the mask 340 may be a standard type of mask. In others, the mask 340 may be designed for the system, for example, by including a raised lip around the edge or the like to assist with maintaining a seal with the hood 310, or the like. The hose 322 is provided between the hood 310 and the blower 320, and the hose 322 allows the blower 320 to provide the hood 310 with pressurized filtered air. The CBRN filter can be 323 provided to an inlet of the blower 320, and the blower 320 can move air through the CBRN filters 323 to filter/purify the air before the blower 320 provides the pressurized air to the hood 310. The pressurized air in the hood 310 generally inhibits outside air from entering the hood at the user's neck area or between the mask and the hood in any case where a seal in those areas is not complete or is disturbed during movement or the like.

In this manner, it is considered that the connection between a hood face opening 310a and the mask 340 can be porous, such that some of the air provided to the hood 310 by the blower 320 will escape between the mask 340 and the hood face opening 310a. In other words, the connection between the hood 310 and the mask 340 at the hood face opening can be non-airtight. However, it is recognised that a pressure setting of the blower 320 can be such as to provide a set (static or dynamically adjusted, as measured by the sensor(s) 220—see FIG. 2A, 2B) amount of air to the hood 310 in order to provide an overpressure, thus providing for a desirable amount of air leakage at the hood face opening 310a and around the seals (positioned on a face of the user) of the mask 340. The overpressure can be defined as a set pressure (or range of pressure) at which the pressure of the hood interior 310b is maintained (e.g. by the controller 325), such that the set overpressure(s) are at a value higher than a baseline pressure (e.g. a mask 340 pressure, ambient pressure (e.g. external to the hood 310), etc.).

Further to the baseline pressure described above, an alternative embodiment of the baseline pressure is where the overpressure is set to a level that is deemed as higher than the air pressure in the mask 340 and ambient environment outside the hood 310, while at the same time incorporating into the set level represents that the designated overpressure is of a set magnitude high enough to overcome critical events experienced by the user of the hood 310, such as but not limited to backdrafts from dynamic movements, operator heavy breathing that causes them to pull in air from the hood 310, increases in the air gaps at the mask 340 and neck openings, etc. Further, it is recognised that the overpressure setting can be such that the system dynamically adjusts to changes in gaps/pressure measured via the sensors (e.g. pressure) associated with the hood 310. Advantageously, the system as described is configured to maintain the pressure within the hood 310 in a defined performance range (e.g. within an upper pressure setting and a lower pressure setting). Advantageously, the system as described is configured to maintain the pressure within the hood 310 with respect to (e.g. over) a defined overpressure setting (e.g. greater than a set pressure setting). Advantageously, the system as described is configured to maintain the pressure within the hood 310 with respect to (e.g. over) a defined overpressure (e.g. over a lower pressure setting). Advantageously, the system as described is configured to maintain the pressure within the hood 310 with respect to (e.g. under) a defined overpressure (e.g. lower than a maximum pressure setting).

FIG. 3A shows a side view of the hood 310 for the system of FIG. 3A. In some cases, the hood 310 can include strain relief strap(s), for example one relief strap 310d located above the hose 322 inlet (to the hood 310) to manage excess hood 310 material (e.g. to gather the hood 310 material together) and inhibit the hose 322 inlet from sagging. Another relief strap 310e can be located at the base of the rear hood flap and connected to the hose 322 to inhibit the weight of the hose 322 from pulling on the hose inlet. It is desirable to have a properly fitting hood to the user, in order to properly fit the hood openings (e.g. hood face opening 310a) to the anatomical dimensions of the user (e.g. head shape, size, etc.) and/or to the dimensions of the mask 340.

FIG. 3B shows a more detailed and partially cut away view of elements of the system 300 of FIG. 3A. The controller 325 is electrically connected to the blower 320 and the power supply 321. The power supply 321 provides the controller 325 with electrical power and the controller 325 or power supply 321 provides the blower 320 with electrical power. The controller 325 may vary the amount of power provided to the blower 320 to control the blower (for example, the blower speed) and thus also control the pressure in the hood 310. The controller 325 can be connected with sensors (not shown in FIG. 3B) to monitor pressure in the hood or more generally in the system. The hood 310 is configured to accept the hose 322 and, also configured to interface with the mask to provide a seal.

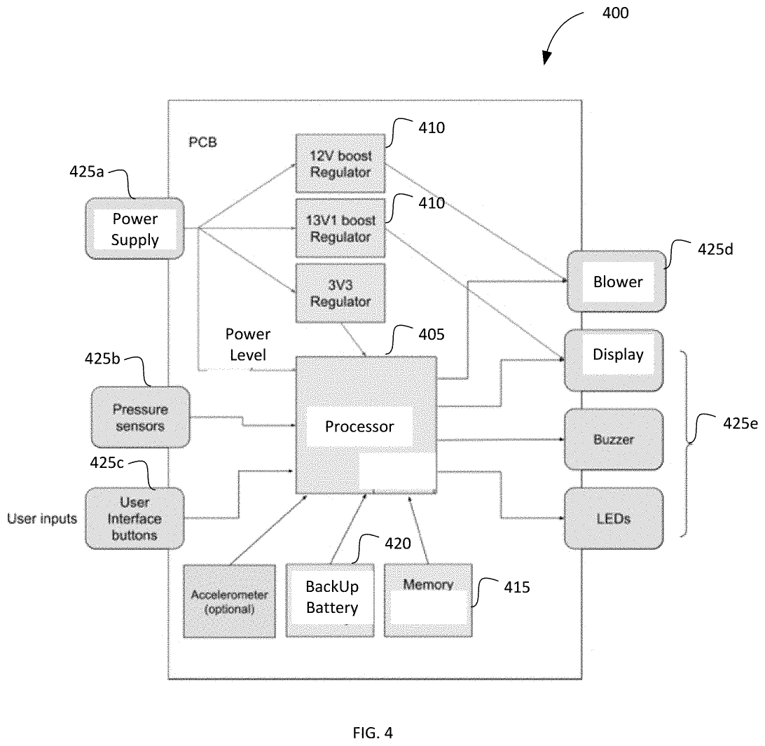

In one embodiment as shown in FIG. 3B, which can be used to address limited system 300 resources, the blower 320 can includes a user interface 326 that displays critical system status information (e.g. via a display 326a) and can act as an input device (e.g. display 326a and/or buttons 326b) for the controller 325. In some cases, the controller 325 facilitates for the selection between two or more modes of operation of the system 300, such that each mode is defined by a respective set of stored parameter(s) 325a (for a first mode), 325b (for a second mode), 325c (for a third mode) in the memory 415 (see FIG. 4) of the controller 325 (see FIG. 3A). In one embodiment, the user can selects between two or more modes of operating the system 300 using a switch 326b, and then the controller 325 implements a respective set of stored parameter(s) based on the user selected position of the switch 326b. It is recognised that the first, second, third modes are just labels, and as such the first mode can be referred to as the second mode while the second mode can be referred to as the first mode, etc.

A first mode could be a static mode such that it runs the blower 320 at a set/predefined (e.g. maximum) fan speed, irrespective of any sensor 220 readings of the pressure(s) of the hood 310 and/or mask 340. In the first mode, the pressure readings are disregarded by the controller 325 and instead the blower 320 runs at a set fan speed irrespective of the air pressure within the interior 310b of the hood 310.

A second mode could run the blower 320 using a control algorithm (stored in memory) that dynamically adjusts (i.e. a variable speed setting performed as a managed mode) the fan speed based on one or more pressure readings collected throughout the system 300. For example, the second mode can maintain the critical pressure (e.g. desired overpressure or overpressure range) in the hood 310 while optimizing power supply 321 and CBRN canister 323 service life.

One situation in which the first mode could be used is in an active user event, such that the user suspects that they will encounter elevated levels of physical activity and/or user perspiration. In this case, the user is not concerned with preserving system resources, rather is more concerned with staying protected by the overpressure operation of the system 300 in the event that the hood 310 and/or the mask 340 become misadjusted and/or are damaged in some way during physical activities of the user. It is recognised that one could have a number of different managed pressure modes, such that each managed pressure mode would have a different set pressure limit(s) or set pressure range, as dynamically managed by altering the blower 320 operation by the controller 325 in response to received pressure readings from the sensor(s) 220.

In this manner, it is recognised that the system 300 can be operated at a plurality of different modes, as further described herein, as selectable by the user for example via the user interface 326.

FIG. 3C shows a frontal view of elements of the system 300 of FIG. 3A. In particular, FIG. 3C illustrates the hood 310 and a hood manifold 313. The hood manifold 313 is provided inside the hood 310 and is configured to direct air within the hood 310 for better air flow and pressurization. In particular, the hood manifold 313 can be configured to direct air to sites of potential seal breaches. In some cases, the manifold 313 is a pliable channel/hose that connects with the hose 322 or a hose inlet of the hood 310 to distribute air within the hood 310. In some cases, the manifold 313 is positioned so that the manifold 313 rests above the shoulders of a user but below the user's chin and can be directed such that ends of the manifold 313 direct airflow to a chin region of a user. In some cases, the manifold 313 can include perforation(s) 313a (e.g. up to three ¼″ holes) along the (e.g. top of) each arm 313b (e.g. one or more arms 313b) to facilitate air to be released along the manifold arm(s) 313b in selected locations, in order to facilitate distribution of the air within selected regions of the hood 310 and/or towards certain direction(s) within the hood 310 (e.g. towards the hood opening interface 310a). It is also recognised that the ends 313c of the arm(s) 313b can also have perforations (e.g. openings) for facilitating the distribution of the air within the hood interior 310b.

In some embodiments, the hood 310 may include one or more retention straps 314 for connecting the hood 310 to the body of the user, a mask opening draw cord 311 for interfacing the hood face opening 310a with the mask 340, and a neck opening drawcord 312 in order to facilitate a seal against the mask 340 and at the neck of a user. In some cases, the mask opening draw cord 311 and the neck opening draw cord 312 may be elastic in order to provide some extension during movement or the like. The mask opening draw cord 311 and the neck opening draw cord 312 are examples of connectors between the hood 310 and the mask 340 or user. The retention straps 314 may connect to a user's clothing or the like.

FIG. 3D shows a side view of the hood 310 and mask 340 for the system of FIG. 3A with the hood 310 shown as transparent. In this case, the mask 340 may include a mask retention harness 342, a mask visor 344, a mask canister connection 346, a mask exhalation valve 348, and a mask seal 350. The mask retention harness 342 is configured to fit around a user's head to hold the mask in place. The mask visor 344 is a viewport for the user. The mask canister connection 346 can be used to attach a filter to the mask 340 directly. The mask exhalation valve 348 allows exhaled air to exit the mask 340. The mask seal 350 is around the edge of the mask 340 and configured to fit with a user's skin to facilitate a seal to the user's face. In this embodiment, the hood 310 is configured to be secured against or along the mask seal via a connector such as the mask/lens opening draw cord 311. The hood 310 is positioned such that the mask opening draw cord 311 is positioned on the mask seal outside of the mask visor 344 and other parts. Tightening the mask opening draw cord 311 via a drawstring lock 352 helps secure the hood 310 to the mask 340 (mask seal 350). It will be understood that other manners of interfacing/connecting the hood 310 to the mask 340 may be used in other situations. For example, hook and loop fasteners or the like may be provided or alternatively, the mask 340 may include a ridge or groove that fits with a corresponding element on the hood 310. In other embodiments, the hood 310 and mask 340 may be integrated such that they are attached together in advance during manufacturing or prior to donning or the like.

Testing according to CSA-Z94.4-2011 has shown that users with beards and/or facial stubble could only achieve a Quantitative Fit Factor (QNFT) of 555 with a conventional mask alone and 830 with a conventional mask in combination with a passive hood (i.e. not connected to a blower 320). These values are well below a target level of 10,000 QNFT. The test results from bearded participants using an initial prototype embodiment of the system herein (e.g. the system 300 as shown in FIG. 3A) in laboratory conditions were well above the target level (18,510 QNFT). Test results from bearded participants using a subsequent prototype embodiment of the system herein in laboratory conditions were further improved to 66,913 QNFT. The subsequent prototype was also tested during an operationally relevant dynamic protocol including rapid horizontal and vertical load transfers, and simulated sight picture acquisition in the standing, kneeling and prone shooting postures. Test results from bearded participants using the subsequent prototype were approximately 66,102 QNFT. In the testing, a TSI model 2026 particle generator produced ambient particle levels at 25,000-65,000 particles/cm3 inside the test chamber and a PortaCount Respirator Fit tester 8040 was used to calculate QNFT values. The initial prototype of the system also improved the protection provided to clean shaven participants, to well above the 30,000 QNFT level. The initial and subsequent prototypes (e.g. systems 300) thus provided an added layer of protection and safety for even close shaven participants. In particular, embodiments of the system generally include a controller 325 that can adjust blower speed to account for changes in micro-environment pressure (i.e. mask or hood pressures) such as may occur when users were performing dynamic activities, as measured via the sensor(s) 220. The controller thus appeared to improve respiratory protection. It is anticipated that favorable results or at least some level of QNFT will also be achieved in field use situations.

FIG. 4 shows an example of a circuit diagram for an embodiment of a controller 400 (sometimes called a microcontroller 325 such as shown in FIG. 3A) to control an embodiment of a system such as the system 300 of FIGS. 3A-3B, and, in particular, a blower included in the system. In this example the controller 400 is a printed circuit board (PCB) and includes a processor 405, one or more voltage regulators 410, a memory 415, a back-up power (battery) 420 and various inputs/outputs. In some cases, the controller may include an accelerometer 430. The various inputs/outputs can include a power input 425a, pressure sensor input(s) 425b, a user interface input 425c, a blower output 425d for controlling the blower, and user interface output 425e. The user interface output may include a display, a buzzer, light emitting diodes (LED), control buttons or the like. It will be understood that embodiments of the controller 400 may be formed as an electronic circuit, miniaturized electronic circuit, PCB or the like. The controller 400 may be controlled by computer code, software or the like to perform the functions required. The computer code may be stored in the memory 415.

Embodiments of the system herein may be configured to work with or be adapted to conventional masks (sometimes called a universal hood system). Alternatively, a custom-built hood specifically sized to the mask and the desired approach to hood donning (before, after or together with mask donning) may be formed.

Embodiments of the system, devices and method herein are intended to overcome at least some of the challenges for sealing a conventional respiratory mask and/or the limitations of a conventional passive hood system. Embodiments are also intended to meet the need for quick donning (for example, approximately 9 seconds) in the event of a Chemical, Biological, Radiological and Nuclear (CBRN) attack. In some embodiments, the overpressure hood may mitigate mask seal leaks even in conventional masks and be seen as a “back-up” to conventional masks. In some cases, the overpressure hood seals around the face plate of the respiratory mask and may be cinched around the lower neck of the user in order to reduce or prevent vapour and aerosol leakage into the mask. As noted above, the overpressure hood is connected to (for example by a hose) a blower system that uses CBRN filtered air to create a predetermined pressure gradient between the air inside the hood and in the surrounding environment. The pressure gradient creates a force, pushing air out of any leaks that may be present in the hood seal and pushing filtered air around any leaks that may be present around the mask (the mask may form an imperfect seal to the user's face and the hood may form an imperfect seal with the mask, user's neck, or the like). By over-pressuring the hood micro-volume, the power and filter requirements are intended to be significantly reduced relative to PAPR systems or the like.

For example, the set overpressure can be calculated by the controller 325 based on a desired pressure differential setting between the measured mask 340 pressure and the deemed internal hood 310 pressure (e.g. pressure measured by appropriately positioned sensors 220). Alternatively or in addition to, the overpressure can be calculated using predefined internal hood 310 pressure setting, as measured by one or more hood pressure sensor(s) 220. In this regard, as air leaks out of the hood 310, the blower 320 would be activated/controlled by the controller 325 in order to dynamically maintain the desired set pressure (or pressures) in the hood 310 interior.

As such, embodiments of the system include a micro-controller and sensors that provide feedback as to whether or not the mask-hood micro-volume is adequately over-pressured. For example, static pressure can be assessed using an electronic manometer or the like.

Embodiments of the system may include the manifold system 313 (see FIG. 3C) that directs air flow to the site of mask seal caused by beards, prescription temple arms, distortions to the respirator associated with weapon sighting, or the like.

In some embodiments, the hood may include carbon-based permeable, selectively permeable membrane, chemically active or impermeable Chemical Biological Radiological Nuclear (CBRN) protective fabrics as the hood material.

The controller can be configured to regulate blower speed such that positive overpressure is controlled within the hood micro-volume (i.e. internal space of the hood not occupied by the user's head and mask 340). Air pressure sensors 220 can be integrated with the system, for example, there may be a general pressure sensor or in some cases there may be pressure sensors at a blower inlet and/or blower outlet, to provide feedback to the controller and/or the user that over pressure is maintained. In some embodiments, the controller may be configured to: increase the blower speed (or power) in response to the pressure being measured as below a predetermined low pressure limit, increase the blower speed (or power) to full speed (or power) in response to the pressure being measured as below a predetermined critical pressure limit, and/or decrease the blower speed (or power) in response to the pressure being measured as above a predetermined high pressure limit. When the pressure is measured to be below the low pressure limit, the blower power may be increased by a predetermined amount and, if after a predetermined amount of time the pressure remains below the low pressure limit, the blower power may be further increased. Likewise, when the pressure is measured to be above a high pressure limit, the blower power may be decreased by a predetermined amount and, if after a predetermined amount of time the pressure remains above the high pressure limit, the blower power may be further decreased. In this way, the desired overpressure setting in the hood 310 can be maintained (e.g. statically or dynamically).

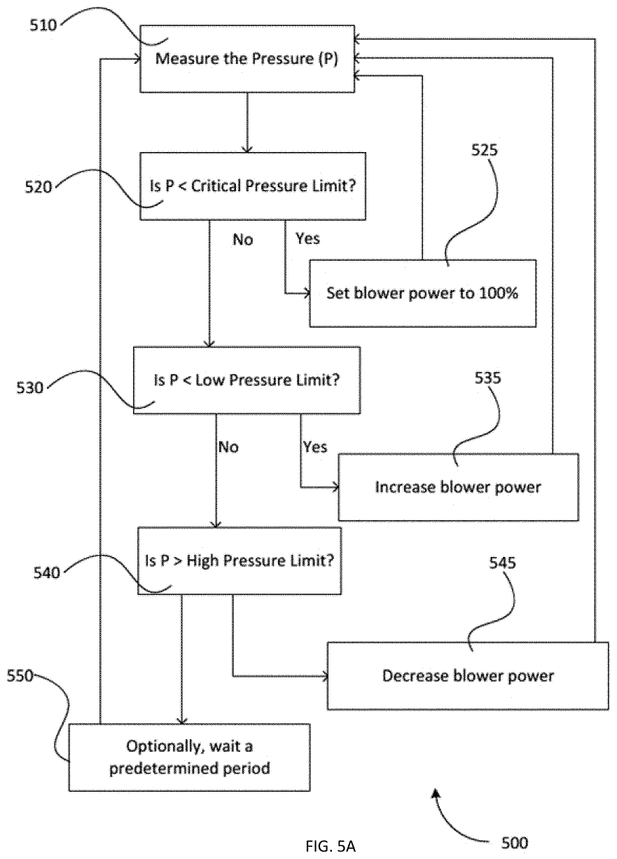

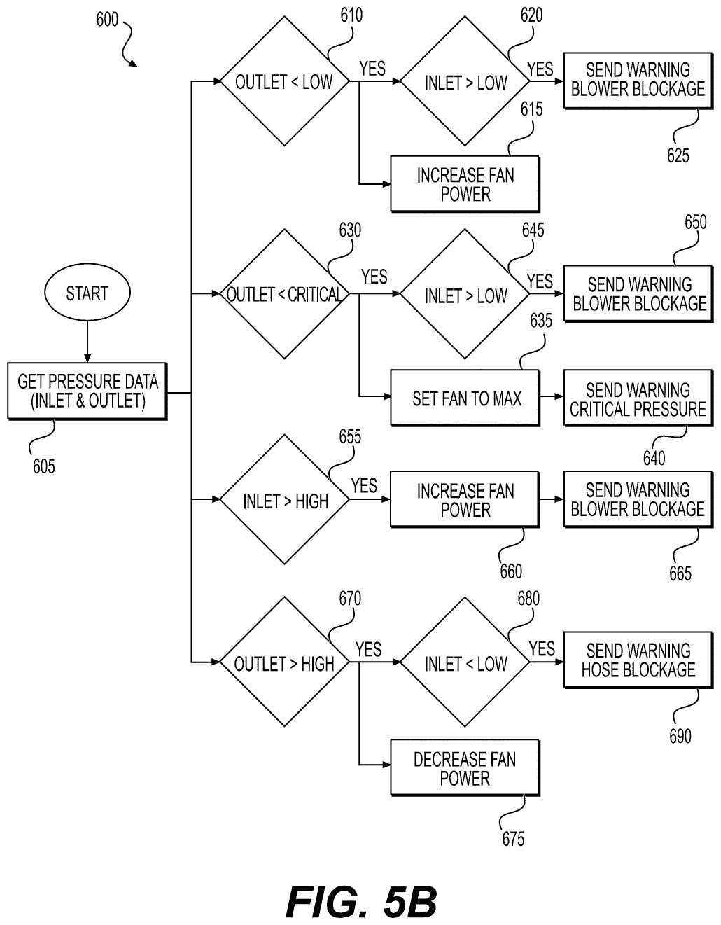

FIG. 5A illustrates an embodiment of a method 500 for protecting against respiratory hazards, and, in particular to control a system such as the system 300 of FIG. 2A-B or 3A-3C. At 510, the pressure (P) inside the hood is measured. At 520, P is compared to a Critical Pressure Limit (or set pressure range). If P is less than the Critical Pressure Limit (or less than the set pressure range), the method proceeds to 525. At 525, the blower power can be set (e.g. at 100%) (in some cases, there may be a time delay or predetermined run time as well) then return to 510. If P is greater than the Critical Pressure Limit (or higher than a set pressure range), the method proceeds to 530. At 530, P is compared to a Lower Pressure Limit (or set pressure range). If P is less than the Lower Pressure Limit (or lower than the set pressure range), the method proceeds to 535. At 535, the blower power is increased before returning to 510 (in some cases, there may be a time delay or predetermined run time as well). If P is greater than the Lower Pressure Limit (or set pressure range), the method proceeds to 540. At 540, P is compared to a High Pressure Limit (or set pressure range). If P is greater than the High Pressure Limit, the method proceeds to 545. At 545, the blower power is decreased before returning to 510 (in some cases, there may be a time delay or predetermined run time as well). If P is less than the High Pressure Limit (or set pressure range), the method proceeds to 550. At 550, an optional predetermined amount of time is waited before returning to 510. The method 500 may be repeated for as long as the respirator is in use, i.e. a constant pressure (e.g. set overpressure) inside the hood 310 is desired. In this manner, the method 500 is one example of power management used by the controller 300, in order to provide a desired overpressure setting in the hood 310 while at the same time preserving power when the hood 310 is at the desired pressure (or within the set pressure range). Further, for example, the method 500 can be used to operate at a selected operational mode (e.g. a first mode, a second mode, etc.) as further described herein from a plurality of available modes to select from using a user interface 326 (see FIG. 3B).

As noted above, in some embodiments, the system may be configured to measure pressure at the blower inlet and outlet via pressure sensors or the like. FIG. 5B illustrates another embodiment of a method 600 for protecting against respiratory hazards. At 605, pressure data readings are taken from the pressure sensors. At 610, blower outlet pressure (Pₒᵤₜ) can be compared to a low outlet pressure limit. If Pₒᵤₜ is less than the low outlet pressure limit, the blower power will be increased at 615, and blower inlet pressure (Pᵢₙ) can then be compared to a blower inlet lower limit at 620. If Pᵢₙ is greater than the low inlet limit, at 625 a warning can be sent that there is a blower blockage. At 630, if Pₒᵤₜ is less than a critical outlet limit, blower power can be set to 100% at 635 and a warning can be sent that critical pressure has been reached at 640, at the same time, at 645, Pᵢₙ is compared to the blower inlet lower limit. If Pᵢₙ is greater than the low inlet limit, a warning can be sent that there is a blower blockage at 650. Further, at 655, if Pᵢₙ is greater than the high inlet pressure limit, fan power will be increased at 660, and a blower blockage warning can be sent at 665. Still further, at 670, if Pₒᵤₜ is higher than the high outlet pressure limit, fan power can be decreased at 675, and Pᵢₙ will then be compared to the blower inlet lower limit at 680. If Pᵢₙ is less than the lower inlet limit at 685, a hose blockage warning can be sent at 690.

While the methods 500 and 600 can be configured to measure pressure in real time or optionally waiting a predetermined amount of time, in alternative embodiments the pressure may be measured at a predetermined rate instead of waiting a predetermined amount of time after each reading. In some cases, the controller will just run continuously and any delay will be related to the processing time, which will typically be quite short. Further, the method may start as continuous but have a delay added if the power is determined to be lower or other combinations based on the desired approach.

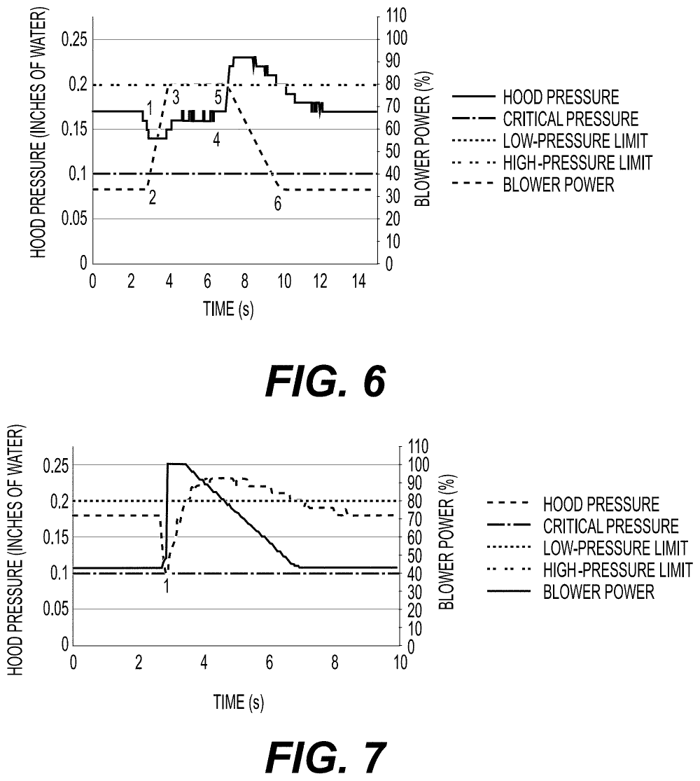

An evaluation of the controller response to leaks in the hood was performed with the prototype system set up on a mannequin using the controller configuration of FIG. 5A. FIG. 6 shows a graph of hood pressure as a function of blower power in a first test of the system to determine appropriate blower operation. FIG. 7 shows a graph of hood pressure as a function of blower power in a similar second test. The tests were conducted on a prototype system of the type shown in FIG. 3. In both the first test and in the second test, if a leak occurred causing hood pressure to decrease below a predetermined threshold, the controller increased the blower power to increase the hood pressure and attempt to maintain a predetermined hood pressure.

In some embodiments, the controller uses a control algorithm involving one or more of the following tasks: altering the power/speed of the blower (for example using pulse width modulation (PWM) or the like), read the pressure inside of the hood, display pressure and blower information to an LCD screen, record timestamped data to an SD card, indicate when pressure readings inside of the hood are below predetermined levels, indicate when the battery is low and should be replaced, and the like.

With these functionalities, the controller can be configured to adjust the blower to maintain a predetermined/desired pressure level within the hood. FIG. 6 shows the response of the controller when a leak was simulated by opening the edge of the hood that is against the mask. Six events during the test, where changes occur in hood pressure or blower power, are summarized below and annotated on the graph:

1. A leak occurs, causing a sudden drop in pressure.

2. The pressure drops below the low-pressure limit (for example, 0.15 in H2O), triggering the controller to increase the blower power.

3. The pressure raises above the low-pressure limit, where the controller holds the blower power steady.

4. The leak closes, causing a sudden increase in pressure.

5. The pressure raises above the high-pressure limit (for example, 0.2 in H2O), triggering the controller to decrease the blower power.

6. The pressure drops below the high-pressure limit and the blower power holds steady.

Many of the same steps occur in FIG. 7, which shows a situation where a sudden, large leak occurs in the hood. However, in this instance the graph illustrates a situation where the pressure reaches a critical pressure (point 1 on the graph), where the controller then sets the blower to 100% and the pressure quickly raises to an acceptable level.

In both FIGS. 6 and 7, the high pressure limit, the low pressure limit, and the critical pressure limit of 0.2, 0.15, and 0.1 inches of water, respectively, were used. These example hood pressure limits were derived for lab based testing. When the pressure in the hood is within these ranges the blower power is typically minimized. It will be understood that the various thresholds can be adjusted depending on the requirements of the system and will likely be different for in-field use of the system.

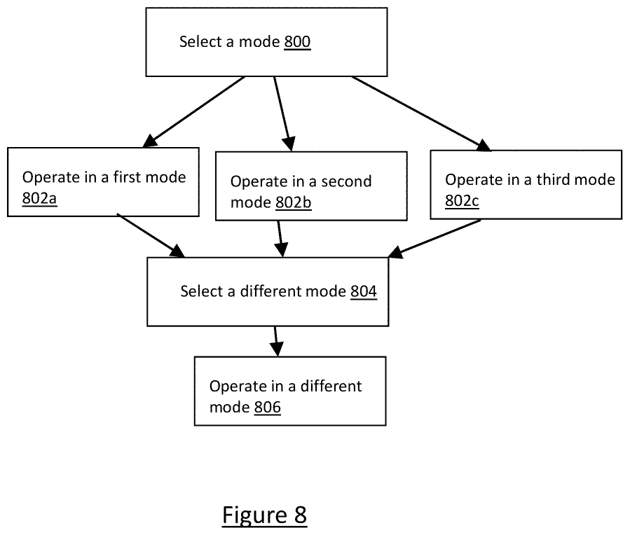

Referring to FIG. 8, shown is a further operation 800 of the system of FIG. 3A. At step 800, the user operates the user interface 326 (see FIG. 3B) by selecting one of a plurality of the blower modes (as embodied by different parameter sets 325a, 325b, 325c for example). Upon selection, at step 802a,b,c the controller 325 operates the blower 320 operation in response to the selected parameter set. As shown in FIG. 8, by example, the first mode is a static mode of step 802a, as represented by the parameter settings 325a, such that pressure readings of the sensors 220 are not used (e.g. are ignored) to dynamically adjust the blower speed. As shown in FIG. 8, the second mode is a dynamic mode of step 802b, such that pressure readings of the sensors 220 are used (e.g. are interpreted by the controller 325) to dynamically adjust the blower speed based on a desired pressure limit(s) contained in the respective parameter set 325b. As shown in FIG. 8, the third mode can also be a dynamic mode of step 802c, such that pressure readings of the sensors 220 are used (e.g. are interpreted by the controller 325) to dynamically adjust the blower speed based on a desired pressure limit(s) contained in the respective parameter set 325c, such that the pressure limits of set 325b are different from the pressure limits of set 325c. At step 804, the user can select a different mode of the plurality of modes, such that at step 806 the controller 325 operates at that different mode. For example, the user can switch back to using the parameter set 325b once the user deems that the first mode (of set 325a) is no longer required, thus facilitating the conservation of system resources, or to otherwise match the set operation of the system 300 to the user task at hand (e.g. heightened user level of activity vs reduced user level of activity, presence of increase degree of perspiration vs not, etc.).

Embodiments of the system and method herein include a respiratory mask and an overpressure hood. The respiratory mask acts as a primary barrier and the overpressure hood overcomes any seal leaks with a micro volume of clean air at the mask seal periphery. If there are leaks, clean air leaks into the mask instead of contaminated air. The over pressure hood micro volume provides a pressure gradient to keep contaminated air out. In testing of a prototype as noted above, personnel with beards and stubble achieve fit factors above 10,000 QNFT and shaved personnel could achieve fit factors above 30,000. With high fit factors, embodiments may reduce the psychological stress and thermal stress (due to the heat of wearing the system) of users. Some personnel may be more prone to encapsulation stress than others, however knowing the effectiveness of the system and the cooling provided by the blower may mitigate panic and claustrophobia suffered by some wearers.

Embodiments described herein use a controller to control air pressure inside the hood to accommodate static and dynamic activities. When personnel are static, air pressure demands are lower and thus battery draw is less, conversely when personnel are moving dynamically leaks may occur more frequently necessitating higher pressure requirements on the blower. Testing to date suggests operational life on battery power and using CBRN canister filters may be over 12 hrs.

In embodiments herein the blower draws air through filters (for example, carbon or other suitable filters) to provide increased pressure under the hood. Based on fluid dynamic principles, the higher internal hood pressure can reduce the amount of contaminated air passing under the hood and thus into the respirator mask. The cross-sectional area of the hood opening where contaminated air could pass and the pressure differentials in breathing has a direct relationship with the pressure that is needed to keep contaminated air out. Embodiments of the system herein are intended to overcome leaks between the cinched hood-neck interface, the hood-mask face seal and the environment. The energy and filter capacity required to provide an appropriate over-pressure (for example, a few psi) can be configured to allow extended operations on a single battery charge.

Embodiments of the system herein are designed to acknowledge that leaks will likely occur but the system overcomes the leaks by supplying purified air to the mask-hood micro environment and thus reduces the amount of contaminants that can reach the inside of the respirator mask.

Embodiments of the system, devices and methods herein are believed to provide at least some of the following improvements over conventional systems and methods: low burden design, that does not require a clean air source or a large battery pack; a controller and sensor system that responds to system pressure drops increasing blower speed to maintain positive hood overpressure; low power draw that will support extended operations on a single battery charge (for example, a single 6V battery provides an estimated 12+ hours of protection); provides protection for any cause of an imperfect seal (loose hair, irregular face shape, presence of prescription eyewear, etc.), not just the presence of a beard; provides additional layered defence even for close-shaven personnel or personnel who cannot achieve a quality mask fit; can utilize conventional masks and filter canisters; and weigh less than, for example, the C420 PAPR system (1.6 Kg) while operating longer on battery power.

In embodiments herein, the controller or microcontroller can be configured to optimize protection and maximize battery life as much as possible. The response of the system is intended to be very fast, for example, in the millisecond range, to respond to face seal leaks.

Embodiments of the system, devices and method herein are intended to have at least some of the following enhanced capabilities and improved efficiencies over conventional solutions: improve the protection performance of a larger variety of mask users and allow all users to focus on operational activities and not worry about inadvertent mask leakage; a low burden design that does not require a pressurized clean air source or large battery pack; two-tiered defence approach that has innate failsafe that offers some level of protection even if the controller or blower fail; an adaptive system to improve efficiency to support extended operations (e.g., increase fan speed when needed and decrease power to save battery when applicable); design provides protection for any cause of an imperfect seal (loose hair, irregular face shape, etc.) not just the presence of a beard; overcomes the issue of imperfect mask-face seals using a low burden design without targeting the specific cause of the break in the seal; provides a flow of air that provides evaporative cooling to the wearers neck and scalp region; may be easily be carried by wearers, either in an IPE bag or potentially attached on a gas mask carrier; may utilize existing masks, canisters and batteries, possibly including rechargeable batteries.

Currently, at least some respirators utilize clip on vision inserts to provide vision correction for users who require prescription lenses. Generally, the use of traditional prescription glasses was not possible due to mask seal leaks at the temple arm mask seal interface.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether the embodiments or elements thereof described herein are implemented as a software routine, hardware circuit, firmware, or a combination thereof.

Embodiments of the disclosure or elements thereof can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claim(s) herein.

In the preceding description, for purposes of explanation, numerous details are set forth in order to provide a thorough understanding of the embodiments. However, it will be apparent to one skilled in the art that these specific details may not be required. In other instances, well-known structures are shown in block diagram form in order not to obscure the understanding. For example, specific details are not provided as to whether some of the embodiments described herein are implemented as a software routine running on a processor via a memory, hardware circuit, firmware, or a combination thereof.

The above-described embodiments are intended to be examples only. Alterations, modifications and variations can be effected to the particular embodiments by those of skill in the art without departing from the scope, which is defined solely by the claims appended hereto.

What is claimed is:

1. A system for protecting against respiratory hazards, the system comprising:
a hood configured to cover a head of a user and interface with a mask, when the mask is positioned on a face of the user;
an air blower connected with the hood in order to provide air to an interior of the hood;
at least one pressure sensor coupled to a controller, the at least one sensor for measuring air pressure at a selected location; and
the controller to receive data from the at least one pressure sensor and configured to control the air blower to dynamically adjust the air pressure in the interior of the hood to a set pressure, such that the controller configures operation of the air blower by an operational mode selected from a plurality of operational modes, such that each of the operational modes are represented by a different set of operational parameters including the set pressure.

2. The system according to claim 1, further comprising a manifold configured to distribute air flow received from the blower inside the hood, such that the manifold includes a perforations positioned at a selected location along an arm of the manifold.

3. The system according to claim 2, wherein the manifold system comprises a branching tube having a pair of arms to conduct air flow to predetermined areas of the hood.

4. The system according to claim 1, wherein the at least one pressure sensor comprises a pressure sensor configured to sense a pressure inside the hood as the selected location.

5. The system according to claim 1, wherein the at least one pressure sensor comprises a pressure sensor configured to sense a pressure inside the mask as the selected location.

6. The system according to claim 1, wherein the at least one pressure sensor comprises an inlet pressure sensor provided at a blower inlet and an outlet pressure sensor provided at a blower outlet.

7. The system according to claim 1, wherein the hood and mask are configured to connect and form an air porous interface at a hood face opening of the hood adjacent to the mask.

8. The system according to claim 1, wherein the set pressure is a set pressure limit.

9. The system according to claim 1, wherein the set pressure is set pressure range.

10. The system according to claim 1, wherein the plurality of operational modes includes a first mode, such that the respective set of operational parameters of the first mode facilitates the controller to ignore the set pressure by disregarding the measured air pressure provided by the at least one pressure sensor.

11. The system according to claim 1, wherein the plurality of operational modes includes a second mode, such that the respective set of operational parameters of the second mode facilitates the controller maintain the set pressure by using the measured air pressure provided by the at least one pressure sensor.

12. The system according to claim 1 further comprising a relief strap connected to the hood, the relief strap for gathering material of the hood in order to adjust a fit of the hood for the user.

13. The system according to claim 1, wherein the relief strap is positioned adjacent to an air hose inlet of the blower to the hood.

14. The system according to claim 1 further comprising a relief strap connected to the hood, the relief strap for connecting material of the hood with an air hose coming from the blower in order to inhibit strain between the hood material introduced by a weight of the air hose.

15. The system according to claim 1, wherein the relief strap is positioned adjacent to an air hose inlet of the blower to the hood.

16. A method for protecting against respiratory hazards using system having a hood coupled to a mask with an air blower connected with the hood in order to provide air to an interior of the hood, the method comprising:
selecting a first operational mode of an air blower from a plurality of operational modes;
operating the air blower based on a first parameter set associated with the first mode in conjunction with available pressure readings from an air pressure sensor;
selecting a second operational mode of the air blower from the plurality of operational modes; and
operating the air blower based on a second parameter set associated with the first mode in conjunction with available pressure readings from an air pressure sensor, such that the second parameter set is different from the first parameter set.

17. The method of claim 16, wherein the operating of the air blower by the first operational mode is performed using a controller by receiving data from the pressure sensor and controlling the air blower to dynamically adjust the air pressure in the interior of the hood to a set pressure.

18. The method of claim 16, wherein the operating of the air blower by the second operational mode is performed using a controller by ignoring data from the pressure sensor when supplying air from the air blower to the interior of the hood, such that a set pressure of the interior of the hood is left unmanaged.
